(19) United States
(12) Patent Application Publication
(10) Pub. No.: US 2011/0226497 A1
(43) Pub. Date: Sep. 22, 2011

(54) DYNAMIC WATER SHIELD FIRE PROTECTION SYSTEM

(75) Inventor: Innocent Hervé Yamodo, Cambridge, MA (US)

(73) Assignee: Innocent Hervé Yamodo, Cambridge, MA (US)

(21) Appl. No.: 12/770,357

(22) Filed: Apr. 29, 2010

Related U.S. Application Data
(60) Provisional application No. 61/340,487, filed on Mar. 18, 2010.

(51) Int. Cl. A62C 3/00

(52) U.S. Cl. 169/45; 169/49

(57) ABSTRACT

A dynamic water shield fire protection system and method is provided for continuously wetting roof and both external and internal wall surfaces of a building with running thin water films for protecting against an impending fire. Unlike conventional sprinkler systems in which water is sprinkled, in the present invention, specially designed nozzles with flat outlets spread flattened water flows at close range directly on the surfaces to protect against fire. Protected from wind, water flowing from adjacent individual nozzles merges into a uniform water film acting as a water shield to protect the surfaces from an impending fire. A drain assembly is installed longitudinally along the bottom of each water protected surface to collect the water running down, enabling water evacuation or recycling. Thus, a fire protection system is provided to protect a building from both exterior and interior impending fire.

### PARENT CASE

This application is a continuation of a provisional application entitled DYNAMIC WATER SHIELD PROTECTION SYSTEM;

### Application No. 61/340,487

Filing date: Mar. 18, 2010

### REFERENCES CITED

U.S. Patent Documents

| | | |
|---|---|---|
| 5,165,482 | November 1992 | Smagac |
| 5,732,511 | March 1998 | Scott |
| 6,450,264 | September 2002 | Christian |
| 6,679,337 | January 2004 | Perry et al. |
| D524,407 | July 2006 | Crowley |

### BACKGROUND OF THE INVENTION

1. Field of the Invention

The present invention is related to fire prevention and extinguishing systems. More particularly, the invention pertains to a new water nozzle fire protection system for preventing a house, a building, or other structure from catching fire as a result of a nearby fire, or internal fire from spreading.

2. Description of the Prior Art

Properties, such as apartments, houses, office buildings, stores and warehouses have to be protected against fire. Many structures are protected from internal fires through an interior fire suppression system, such as an interior sprinkler system. However, sprinkler systems have the disadvantage of spreading water on furniture, electrical equipment, machines or goods. Moreover, the exterior of structures are often left unprotected from exterior fire threats such as direct flying fire from burning bush and direct or radiant heat generated from a fire in a neighboring building.

During a fire emergency, due to threat of fire damage on properties such as apartments, houses, office buildings, stores or warehouses, the length of time of reaction to fight the fire is critical regarding the outcome of fire damage. Moreover, in a lot of cases, such as a wildfire, a multi structure fire or fire at a remote location, the resources available to local firefighters are often limited. So, in despair to save their properties, owners often take additional fire protective measures, such as garden hoses or lawn sprinklers, as common approaches to fight fire. Weak water pressure, impossibility to reach all places where the fire is spreading, high winds, heat and thick smoke make such attempts very dangerous and often inefficient because of the high risk of injury with life threatening wounds or burns. Other limitations for using garden hoses or lawn sprinklers are, first, the user has to be physically present at the site during impending fire or fire progression; second, lawn sprinklers and garden hoses are not useful in case of interior fires because of accessibility, water pressure and risk of toxic smokes or injury.

Several approaches to create an exterior fire suppression system have proven to be impractical or not efficient. For example, U.S. Pat. No. 5,165,482, entitled “FIRE DETERRENT SYSTEM FOR STRUCTURES IN A WILDFIRE HAZARD AREA,” issued on Nov. 24, 1992, was designed to operate in a preemptive manner by detecting the impending approach of a wildfire within the vicinity of the structure to be protected. The system includes apparatus to identify the locus and direction of spread of a fire while it is outside of a defensive perimeter that encircles the structure and extends outward there from. Pre-wetting the structure and surrounding vegetation is supposed to reduce the probability of local fires caused by wind-borne embers and reduces the combustibility of these materials to assist fighting the fire.

There is an approach described in U.S. Pat. No. 5,732,511 entitled “ROOF MOUNTED FIRE PROTECTION SYSTEM,” which was issued on Mar. 31, 1998. In this patent, a roof mounted fire protection system is adapted to be used in association with a house positioned upon a yard, the house having a pitched roof with an apex and a side wall. As others, using a plurality of sprinklers, this approach intends to fight impending fire by spreading water against the roof and walls.

A similar approach was attempted in U.S. Pat. No. 6,450,264 entitled “SPRINKLER SYSTEM”, issued on Sep. 17, 2002. In this patent, a piping assembly is adapted to extend along a peak of a roof of a building and along an underside of eaves of the building and along a fence line; it also includes a shield assembly including an elongated shield member being adapted to extend along the peak of the roof of the building and also including shield support members being adapted to fasten to the roof of the building for supporting the elongated shield member; and further includes a water assembly being connected to the piping assembly for supply water to the piping assembly; and also includes a pump/control assembly being connected to the water supply assembly and the piping assembly for delivering water to the piping assembly.

Another earlier approach described in U.S. Pat. No. 6,679,337, issued on Jan. 20, 2004 and entitled “WATER SPRINKLER FIRE PREVENTION SYSTEM”, describes a water sprinkler frame having a plurality of linear portions and including a plurality of sprayer nozzles extending radially from the pipe and out an associated opening in one of the faces of the heat shield. In operation, the nozzles function for spreading water therefrom upon the receipt thereof.

The most recent and related approach to my invention is a proposed design described in U.S. Pat. No. D524,407, entitled “UNDER-EAVE FIRE SUPPRESSION SPRINKLER BANK”, which was issued on Jul. 4, 2006. In this design patent, the fire prevention system is an under-eave fire suppression bank supporting a linear pipe with a plurality of sprinklers spreading water on the surface of the house to be protected.

These and other prior art approaches suffer from many drawbacks that have prevented the widespread implementation of fire suppression systems. They suffer from the fact that they use water spray, which is easily dispersible by the wind and requires high water pressure which is not often available during a fire emergency when several properties can be simultaneously threatened by fire. Another limitation of the other prior art approaches is that their installation is complicated and, more importantly, they do not protect both the exterior and the interior of the structures they are intended to protect against fire without damaging belongings inside. Not to mention that these systems are not aesthetically designed and once installed would be considered an eyesore in many communities. In addition, their pipes are exposed to the environment, which can lead to corrosion making the system not only unsightly, but also unreliable. Furthermore, many homes and other structures are designed with roofs having various shapes and slopes that are not contemplated by these limited systems.

In view of all of these prior attempts in design of an efficient and aesthetic water system protection against fire, and the drawbacks in the prior art, there is a need for an improved exterior fire protection system. Furthermore, in light of existing prior art addressing either prevention of an exterior and prevention of an interior fire, there is a need for a fire prevention system to be able to prevent exterior and interior fires at the same time.

It would be desirable for the system to be aesthetically pleasing and capable of effectively saturating the structure's exterior and interior surfaces using the water pressure that is available during a fire emergency. It would be further desirable for the system to be easy to operate without endangering the safety of the occupants and firefighters and inexpensive to install or retrofit into existing structures of various sizes and shapes. In these respects, the dynamic water shield fire protection system according to the present invention substantially departs from the conventional concepts and designs of the prior art, and in so doing provides a full system of apparatus primarily developed for the purpose of preventing a building from catching fire as a result of a nearby fire and/or an interior fire from spreading. In an alternate embodiment, the present invention can be utilized with other existing water based fire extinguishing systems such as ceiling sprinkler systems. The present invention may be adapted to prevent fire in any structure susceptible to be destroyed by fire such as wooden boats, or ships. It may also be adapted to aid in cooling structures in warm climate areas, and so, reduce the cost of air conditioning by providing a wet and uniform water film on the roof and walls.

### BRIEF SUMMARY OF THE INVENTION

In regard of the foregoing disadvantages in the previous types of the fire prevention and fire extinguishing systems now present in the prior art, the present invention provides a new and efficient water nozzles fire protection system construction wherein the same can be used for preventing a building from catching fire as the result of nearby fire or an interior fire from spreading, without flooding or damaging belongings inside the building.

The general purpose of the present invention, which will be described subsequently in greater detail, is to provide a new dynamic water shield fire protection system and methods which have many of the advantages of extinguishing systems mentioned heretofore and many new features that result in which is not anticipated, rendered obvious, suggested, or even implied by any of the prior art fire extinguishing systems, either alone or in any combination thereof. This is by mainly focusing on creating a thin and protective water film, rather than spreading water, to prevent fire.

To attain this, the present invention generally comprises a pressurized water system, a fluidly interconnected network of longitudinal secondary water pipes and a plurality of nozzles. The pressurized water system, through a main water pipe, provides water under pressure to the secondary water pipes connected to a plurality of nozzles via connecting pipes. The nozzles are designed in such a way that the water flow is flattened to become a water film spreading on and covering the surfaces to be protected against fire. The pressurized water is brought to the integrated network of secondary water pipes by a main water pipe fluidly connected to a pressurized water supply system, wherein the pressurized water supply system may be a pump connected to a source of water supply such as a pool, tank, lake, river or other. It has to be noted that water supplies already delivered under pressure, such as fire hydrant, wet standpipe or house tap water supply, may be used as an alternative to a pump and water supply. In one preferred embodiment, a secondary water pipe, in fluid communication with the pressurized water supply system, is mounted along the edge of the roof, while for the protection of vertical walls, secondary water pipes are installed along the highest line of the wall surfaces. Both exterior and interior sides of vertical walls are protected by secondary water pipes installed using the same apparatus on both sides of wall surfaces. The nozzles connected perpendicularly to the secondary water pipes are oriented in such a way that the water flow coming out from the nozzle outlets is spread on the roof and on the walls as a water film. Water flooding is prevented in the interior compartments by a horizontal wall-gutter, connected to the exterior or to the evacuation plumbing system along the bottom of the interior side of each wall. Horizontal wall-gutters may be installed also at the bottom of exterior sides to collect also water coming down wall exterior surfaces. Redirected to a water stock such as a tank or a pool, the water can be recycled to be reused over again. Such water recycling option is particularly interesting in environments with limited water resources.

The water supply system may be connected to fire detectors placed inside and outside the house to automatically supply pressurized water to the integrated network of pipes connected to the plurality of nozzles spreading the water film. These detectors are connected to a control box for transmitting fire signals thereto upon the detection of signals greater than a predetermined point to trigger the activation of the pump or other present water supply system or a sound alarm. A filter screen may be installed inside the intake end of the vertical main pipe to prevent clogging of the system by debris or particles from the water supply. Finally, a plurality of valves, controlling the water flow and placed at selected locations, may be installed inside the water pipes and connected to the control box for bringing pressurized water only to the areas where it is needed and so, reduce the amount of the water to be used.

There has thus been outlined, rather broadly, the more important features of the invention in order that the detailed description thereof that follows may be better understood, and in order that the present description of the art may be better appreciated. There are additional features of the invention that will be described hereinafter and which will form the subject matter of the claims.

In this respect, before explaining at least one embodiment of the invention in detail, it is to be understood that the invention is not limited in its application to the details of the construction and to the arrangements of the components set forth in the following description or illustrated in the drawings. The invention is able of other embodiments and of being practiced and carried out in various ways. Also, it is to be understood that the phraseology and terminology employed herein are for purpose of description and should not be regarded as limiting. As such, those skilled in the art will appreciate that the conception, upon which this disclosure is based, may readily be utilized as a basis for design of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art of who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new dynamic water shield fire protection system and method which has many of the advantages of the fire extinguishing systems mentioned heretofore and many novel features that result in a new dynamic water shield fire protection system which is not anticipated, rendered obvious, suggested, or even implied by any of the prior art fire extinguishing systems, either alone or in any combination thereof. It is a further object of the present invention to provide a new dynamic water shield fire protection system which is of a durable and reliable construction.

An even further object of the present invention is to provide a new dynamic water shield fire prevention system which is susceptible of a low cost of manufacture with regard to both material and labor, and which accordingly is then susceptible of low cost prices of sale to the consuming public, thereby making such dynamic water shield fire protection system economically available to the buying public.

These together with other objects of the invention, along with the various features of novelty which characterize the invention, are pointed out particularly in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic general view of the principle of the present invention.

FIG. 2 is a schematic perspective view of installed water pipes of the dynamic water shield fire protection system on a house.

FIG. 3 is a schematic top view of installed pipes of the dynamic water shield fire protection system on a roof.

FIG. 4 is a schematic view of the dynamic water shield fire protection system installed on a typical two floor building with a flat roof (A) or a hipped roof (B).

FIG. 5 is a schematic diagram depicting the location of valves inside the vertical main water pipe and the secondary water pipes.

FIG. 6 shows detailed views of a wall-nozzle.

FIG. 7 shows supplementary detailed views of a wall-nozzle.

FIG. 8 is a perspective view of a portion of a linear flat shield.

FIG. 9 is a side cross-section of a linear flat shield.

FIG. 10 shows perspective (A) and cross-section perspective (B) views of a wall-nozzle plate support.

FIG. 11 is a side cross-section view of a wall-nozzle plate support.

FIG. 12 shows the steps of mounting of a wall-nozzle to a linear flat shield.

FIG. 13 is side view (A) of an installed wall piping assembly and an enlarged view (B) of the embodiment of a wall-nozzle anchored to a linear flat shield via a wall-nozzle plate support.

FIG. 14 is side view (A) and perspective view (B) of an installed wall piping assembly with a linear flat shield (transparent).

FIG. 15 is a perspective view (A) of a portion of installed wall piping assembly showing the linear flat shield and the same view with a hole in the linear flat shield to show the connection of wall-nozzles to a longitudinal secondary water pipe (B).

FIG. 16 is a view of an installed wall piping assembly on exterior (A) and interior (B) sides of a wall with an enlarged view of a drain assembly (C).

FIG. 17 is a perspective view of a dynamic water shield protection system installed inside a room.

FIG. 18 shows embodiment of wall-nozzles on a secondary water pipe mounted horizontally (A and C) and non-horizontally (B and C).

FIG. 19 is a perspective view of a portion of a longitudinal linear curved shield.

FIG. 20 is a side cross-section view of a portion of a longitudinal linear curved shield.

FIG. 21 shows side view (A) and perspective view (B) of an installed wall piping assembly with a linear curved shield (transparent).

FIG. 22 is a perspective view (A) of a portion of installed wall piping assembly with linear curved shield and the same view with a hole in the linear curved shield to show the connection of wall-nozzles to a longitudinal secondary water pipe (B).

FIG. 23 shows detailed views of a roof-nozzle to be used for roofs and inclined surfaces.

FIG. 24 shows supplementary detailed views of a roof-nozzle to be used for roofs and inclined surfaces.

FIG. 25 shows perspective (A) and side (B) views of the portion of an installed roof piping assembly while C is a diagram illustrating the connection of roof-nozzles to a secondary water pipe.

FIG. 26 is perspective view of a portion of an installed roof piping assembly and the connection of the roof secondary water pipe to wall secondary water pipes.

FIG. 27 is a schematic side section view of a house depicting an embodiment of the dynamic water shield fire prevention system with the location and position of the vertical pipe, wall piping assembly and roof piping assembly (A) with enlarged view of a wall piping assembly (B) and a roof piping assembly (C).

### DETAILED DESCRIPTION OF THE INVENTION

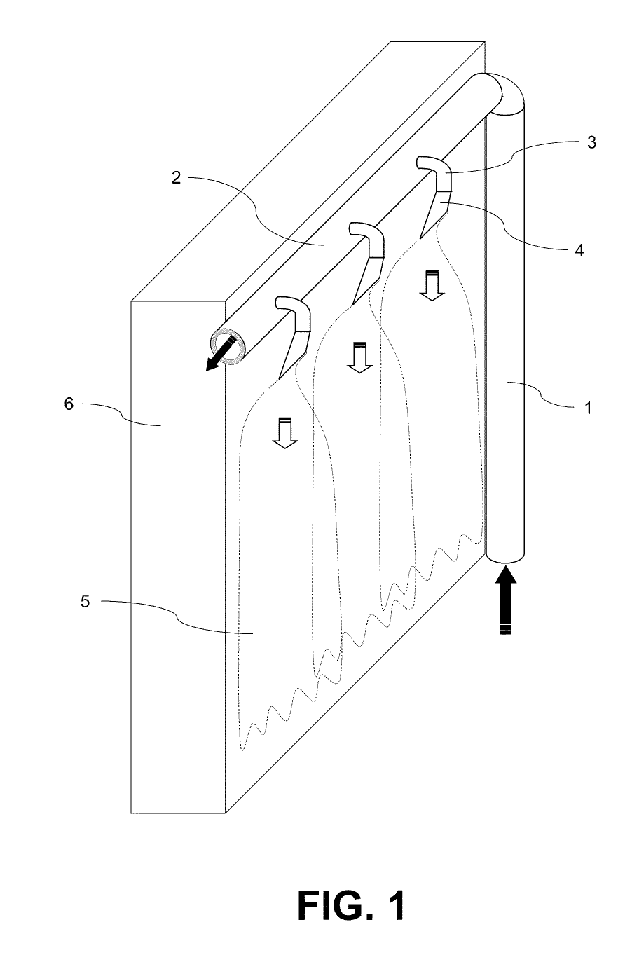

With reference now to the drawings, and in particular to FIGS. 1 through 27 thereof, a dynamic water shield fire protection system embodying the principles and concepts of the present invention will be described.

To help better understand the present dynamic water shield fire protection system, it will be described in the following order: First, the description will paint the fundamental principle of the invention followed by a panoramic and general description of its embodiment in a building. Second, the nozzles used in the present invention for walls will be described in detail followed by the description of their installation in an example of an embodiment. Third, the nozzles used in the present invention for roofs will be described in detail followed by the description of their installation in an example of an embodiment. Finally, in the last part of the description, a general view of a house with a full embodiment of all parts of the invention will be described to highlight their relative locations and functions during operation.

The fundamental principle of the present invention is that, rather than being spread as a shower in the air or against surfaces, the water is brought directly on the surfaces as a moving water film serving as a shield to protect surfaces from catching fire or as extinguisher. The water film being already on the surface, it is less dispersible by wind. Thus, the present invention is particularly adapted for threatening fire in a windy environment. More, for vertical surfaces such as walls, because the water film runs directly on the surface, it can be easily recovered with a drain piping system installed horizontally at the bottom. Thus, the used water can be recycled and reused again. Furthermore, because the water is not spread under pressure with sprinklers as a shower but by gravity as a water film directly on surfaces to protect, the amount of water and the pressure of water necessary to cover a given surface are lowered. These are being two critical parameters for fighting fire during a fire emergency where several properties could be threatened by an impending fire. Finally, combined with a drain piping system, the use of water film, rather than water shower, gives to the present invention the possibility to protect both interior and exterior of a building without damaging belongings in the interior compartment and without important modification of their existing appearance.

Thus, as summarized in FIG. 1, pressurized water, depicted by the black arrow, is forced up inside a main water pipe 1 connected to a longitudinal secondary water pipe 2 that is mounted along the highest line of the wall 6 surface to protect. A plurality of wall-nozzles 4 (only three are shown in FIG. 1) are connected to the longitudinal secondary water pipe 2, via a plurality of connecting pipes 3, at spaced locations and with their flattened outlets oriented parallel and toward the wall surface to spread the water therefrom upon the receipt thereof as multiple flat water flows merging together to form a uniform water film shield 5 preventing the wall surface from catching fire. It has to be noted that in an alternative embodiment, the plurality of connecting pipes 3 connected to nozzles 4 can be replaced with only a plurality of connecting pipes with flat outlets. In such embodiment, the connecting pipes 3, connected to the secondary pipe 2, spread the water without the need for nozzles 4. In an another alternative embodiment, both options of secondary pipes 2 coupled to connecting pipes 3 with and without nozzles 4 may be combined.

Same embodiments are adapted for the protection of inclined surfaces such as roofs with the nozzle 4 or connecting pipe 3 outlets oriented toward the inclined roof surface and parallel to the eaves.

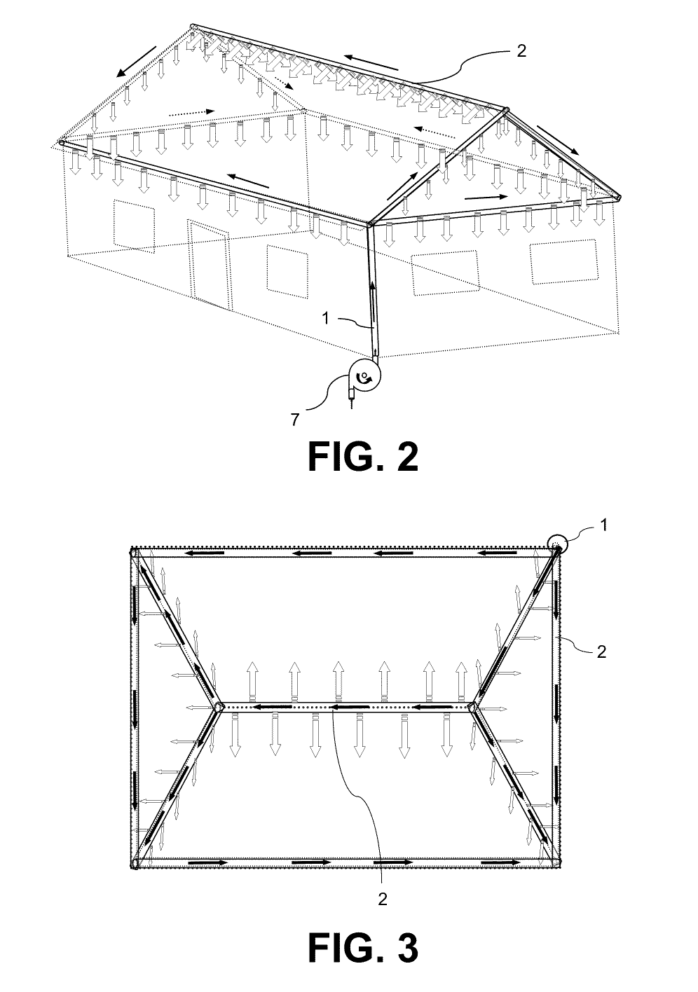

In a preferred embodiment, when the system is mounted on a house, as shown in FIG. 2, a water pump 7 brings pressurized water to a main water pipe 1 in fluid communication with a network of secondary water pipes 2 installed along the crest of the roof and along the highest line of each vertical wall. Alternatively, the main water pipe 1 may be connected to any pressurized water supply such as a municipal water supply. Pressurized water circulating in the longitudinal secondary linear pipes 2, depicted by the thin black arrows, is spread against the walls and the roof, through a plurality of nozzles, depicted by the white arrows. Thus, an installed water shield fire protection system can cover potentially all the surfaces of a house with a water shield against an exterior impending fire. It has to be noted, as it will be further described below, that the system may be adapted to cover also the interior wall surfaces of a house and thus prevent interior fire threat. FIG. 3 shows an embodiment of the present dynamic water shield fire protection system on the top of the roof of a house depicting the circulation of the water in the secondary water pipes 2 from the main water pipe 1, depicted by the black arrows, and the location of the plurality of nozzles spreading water as depicted by the white arrows.

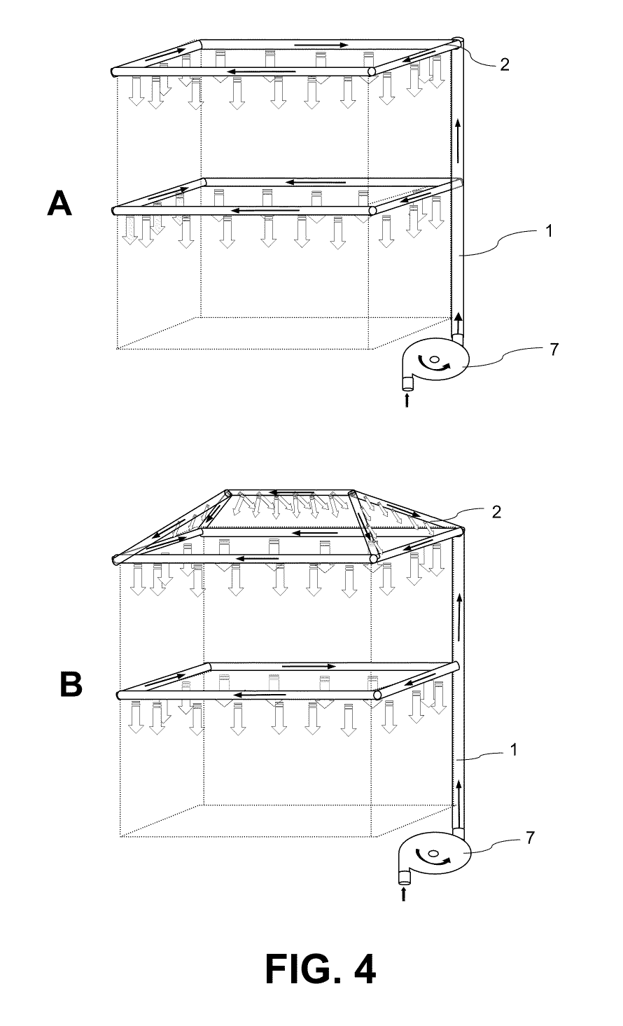

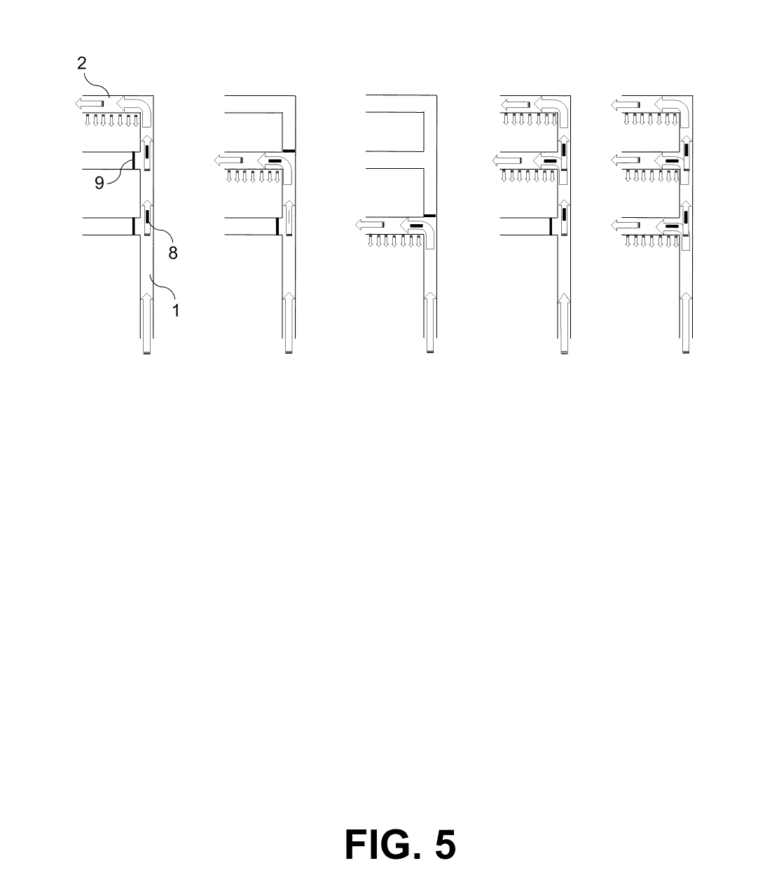

The present dynamic water shield fire protection system is adaptable also to protect other types of buildings against fire. FIG. 4 shows an embodiment of the system installed in a building with a flat roof (A) or with a hipped roof (B) and two floors. The circulating pressurized water, depicted by the thin black arrows, in the longitudinal secondary linear water pipes 2 that are connected to a plurality of nozzles, depicted by the white arrows, is spread against the walls and the roof, covering thus potentially all exterior surfaces of the building with a water film against an impending fire. It has to be noted also again that the system may be adapted to cover the interior wall surfaces of a building. In a preferred embodiment, valves connected to a control assembly may be installed inside the main water pipe 1 and in the secondary water pipe 2 to direct the water only to the nozzles at specific locations as illustrated schematically by FIG. 5 depicting a three floor building. Thus, valves 8 in the main water pipe 1 would determine the floor of the building to bring the water to the spreading nozzles while valves 9 in the secondary water pipes 2 would determine which location in a given floor of the building water will be brought to the spreading nozzles.

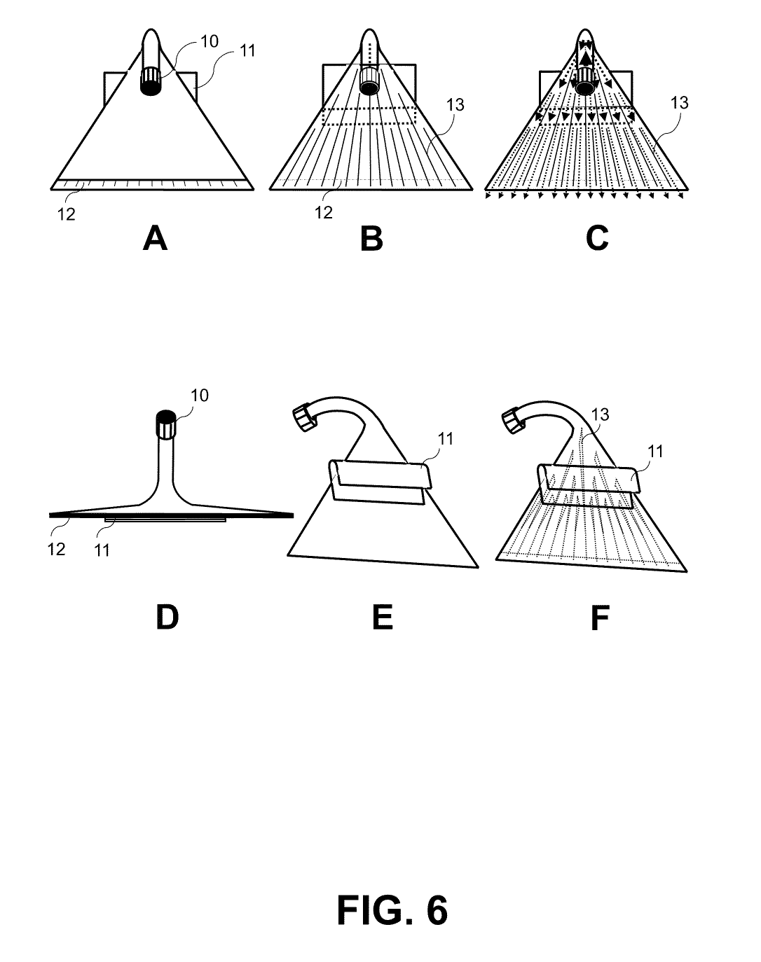

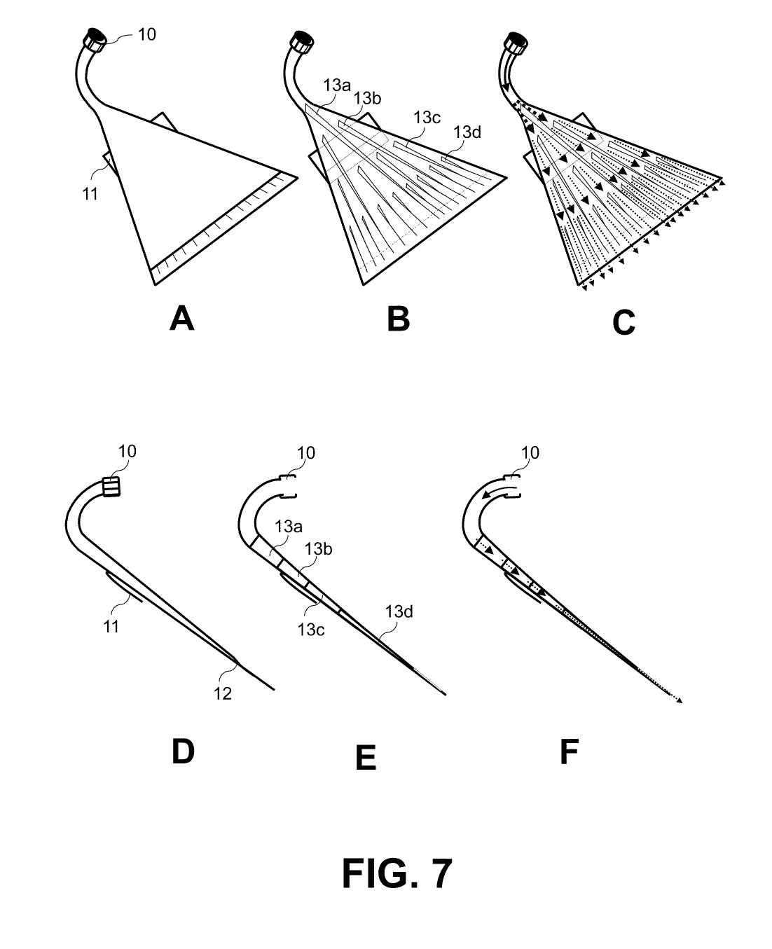

After describing an embodiment of pipes distributing pressurized water to different locations of a house or a building, nozzles used for wall water coverage will be described in detail. Thus, FIGS. 6 and 7 show different detailed views of a wall-nozzle where FIG. 6A depicts a top front external view of the nozzle with a female thread end 10 for inlet connection to a secondary water pipe, through a connecting pipe. A back-anchor 11 is designed for the anchoring of a wall nozzle to a longitudinal linear flat or curved shield while the flattest part of the nozzle ends with the outlet of the nozzle 12. In alternative, the neck of the nozzle can be bent to facilitate the connection to a connecting pipe. FIG. 6B is a transparent view of a wall-nozzle 4 showing inside to reveal the disposition of directional blades 13 to direct the water flow, coming from the neck of the nozzle, to be distributed equally on all the internal surface of the nozzle, and water exiting out its outlet 12 as depicted by the arrows in the FIG. 6C. As shown in FIGS. 6B, 6C and 6F, the internal directional blades 13 are disposed radially in the flat part of the nozzle from the cylindrical neck to the outlet of the nozzle. FIG. 6D shows a front view of a wall-nozzle depicting the female thread 10 of the nozzle inlet, the flatness of its outlet 12 and the location of the back-anchor 11 while FIGS. 6E and 6F are perspective exterior rear view depicting the location of the back-anchor 11. FIG. 6F is also a perspective rear transparent view depicting the disposition of the directional blade 13 and location of the back anchor 11. For a better description of a wall-nozzle, and the role of the directional internal blades, front and side views are presented in FIG. 7. FIG. 7A illustrates a perspective external view of a wall-nozzle 4 depicting the female thread end 10 and the back-anchor 11 while FIG. 7B illustrates a transparent perspective view of the nozzle to reveal the size and the radial disposition of the internal directional blades 13 (13a-13d). The layout of the blades is depicted in FIG. 7B and their effect on water flow is shown in FIG. 7C. During operation when the water flow enters in the cylindrical neck of a wall-nozzle, it is separated into two secondary water flows by a primary directional-blade 13a positioned starting right at the end of the neck. These secondary water flows are themselves separated into four tertiary water flows by two secondary directional-blades 13b. Downstream, the four tertiary water flows are separated into eight quaternary water flows by four tertiary directional-blades 13c. Finally, the quaternary water flows are separated by quaternary directional-blades 13d into sixteen smaller water flows exiting from the nozzle to be spread on the wall to protect from fire. Alternative design could include a lower or greater number of directional-blades to be adapted to particular embodiments. FIGS. 7D to 7F show side views of a wall nozzle depicting its progressive flatness from the cylindrical and curved neck inlet end with a female thread 10 to the flat outlet 12, the location of the back-anchor 11, shown in FIG. 7D, the size and shape of the internal directional blades 13, shown in FIG. 7E and the flow of the water shown in FIG. 7F.

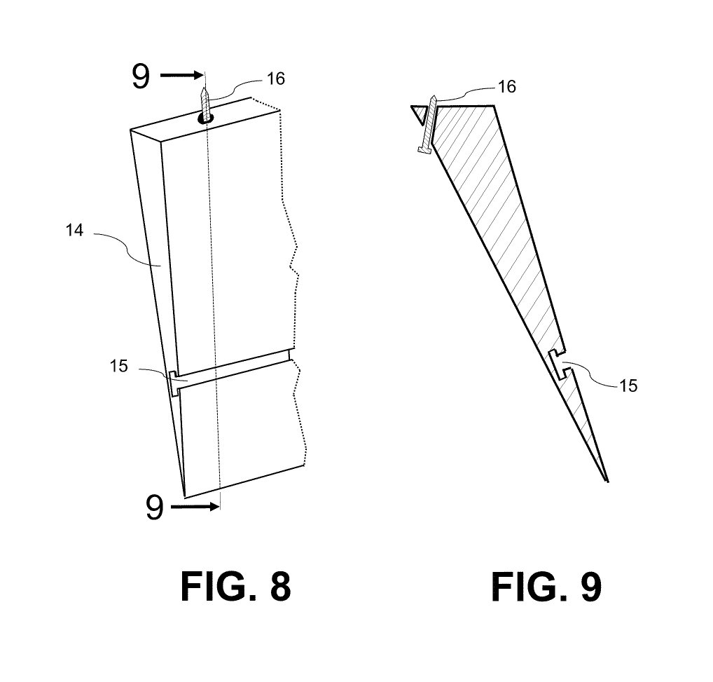

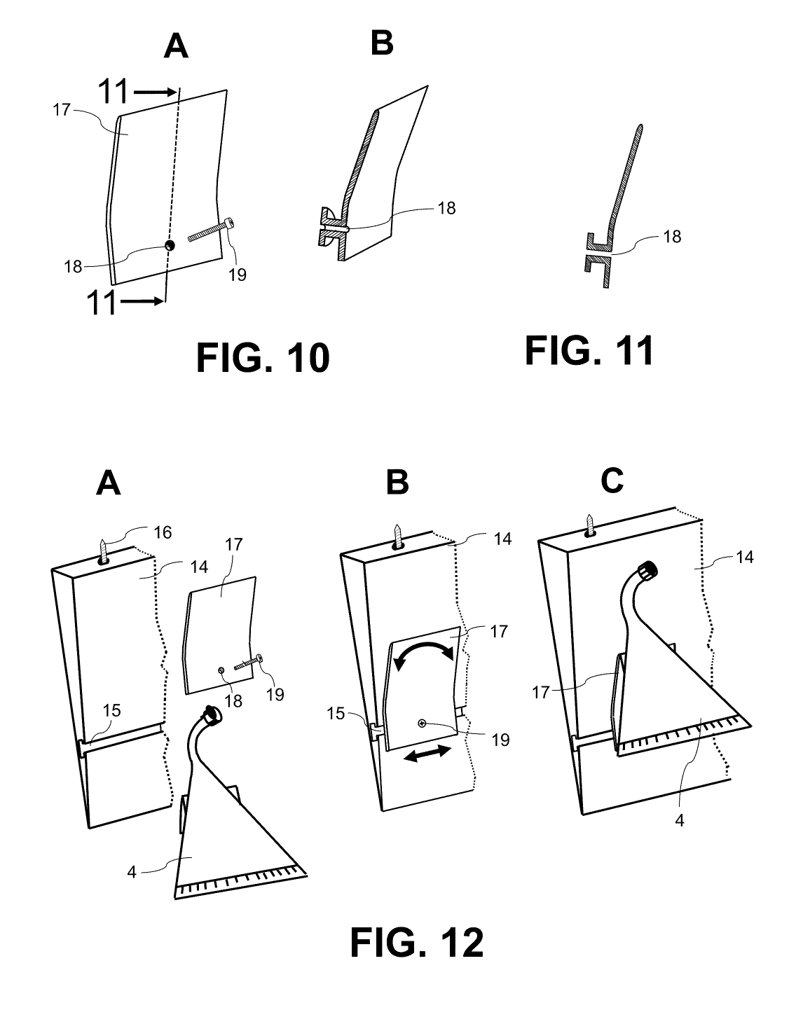

Wall-nozzles are mounted behind longitudinal linear shields serving decorative as well as support purpose. Two types of linear shields may be used in different embodiments: a linear flat shield and a linear curved shield. FIG. 8 shows a portion of a linear flat shield 14 and depicts a longitudinal track 15 to enable the mounting of wall-nozzles as it will be described in detail later and a hole with a threaded fastener 16 to enable attachment to a ceiling. FIG. 9 is a side cross-section view to depict the triangular-shape of the flat linear shield 14 and the angle of the hole for the threaded fastener 16 to be used for attachment to a ceiling. For mounting a wall nozzle on a linear flat shield or on a linear curved shield, a wall-nozzle plate support is used. As illustrated in FIG. 10, a wall-nozzle plate support 17 is a plate with flat surface and being slightly bent lengthwise with, in the back, a cylindrical neck with a central hole 18 crossing through and a circular foot that is to be used to attach the plate with a threaded fastener 19 to a linear shield. FIG. 10A is a perspective view depicting the shape of a wall-nozzle plate support and the lower central location of the hole to enable its installation. A perspective cross-sectional view is shown in FIG. 10B to highlight the location of the rear neck and the circular base crossed by the hole 18. FIG. 11 shows a side cross-section view of a wall-nozzle plate support 17 with a hole 18 crossing through the cylindrical neck and the circular base.

After being described separately, the assembly and adjustment of a wall-nozzle on a longitudinal linear flat shield, using a wall-nozzle plate support is illustrated in FIG. 12. Thus, in FIG. 12A are shown a portion of a linear flat shield 14, with its longitudinal track 15 and a hole with a threaded fastener, a wall-nozzle plate support 17 with the hole 18 for the threaded fastener 19, and a wall-nozzle 4. A sequence of the assembly could be the following; first, the wall-nozzle plate support 17 is mounted on the longitudinal linear flat shield 14 as illustrated in the FIG. 12B. The circular base of the wall-nozzle plate support 17 is dragged along the internal face of the linear flat shield 14 by using the longitudinal directional track 15 as depicted by the horizontal black arrows. Upon reaching the right position, a threaded fastener 19 is introduced in the hole 18 of the wall nozzle plate support 17. The orientation of the wall nozzle plate support 17 is then adjusted by rotating clockwise or counterclockwise, as depicted by the semi circular black arrows, and firmly secured with a threaded fastener 19. The last step is to anchor the wall-nozzle 4 to its wall-nozzle plate support 17 as shown in FIG. 12C. Depending on the length of the wall to be protected, the process is repeated as necessary for each wall-nozzle 4 to fully and efficiently cover all surface of the wall.

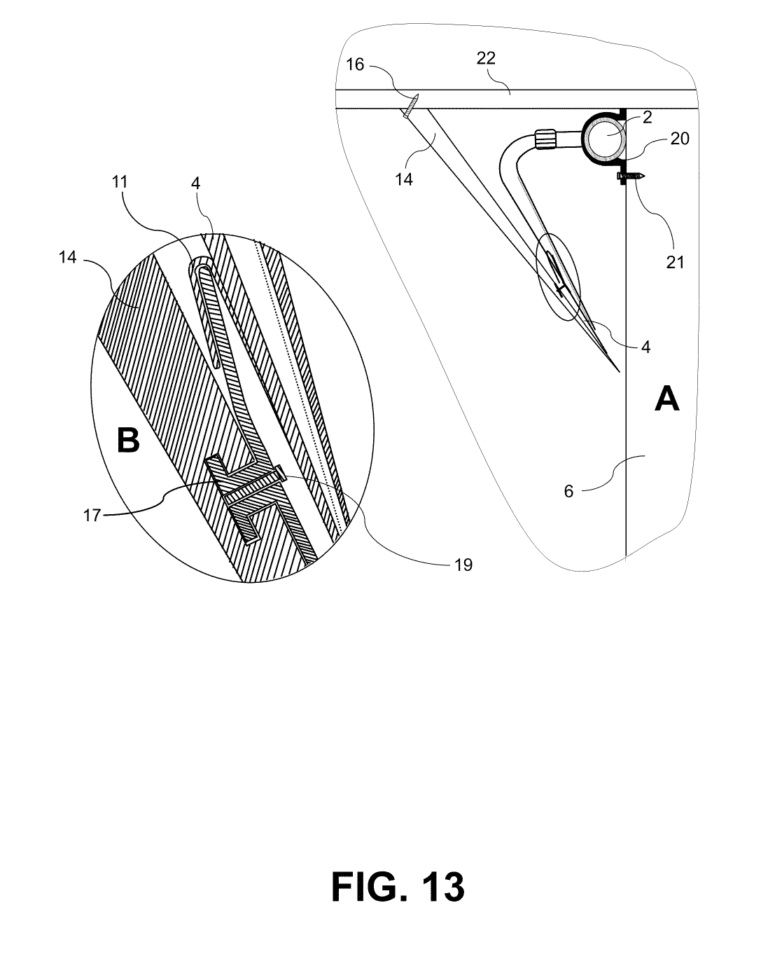

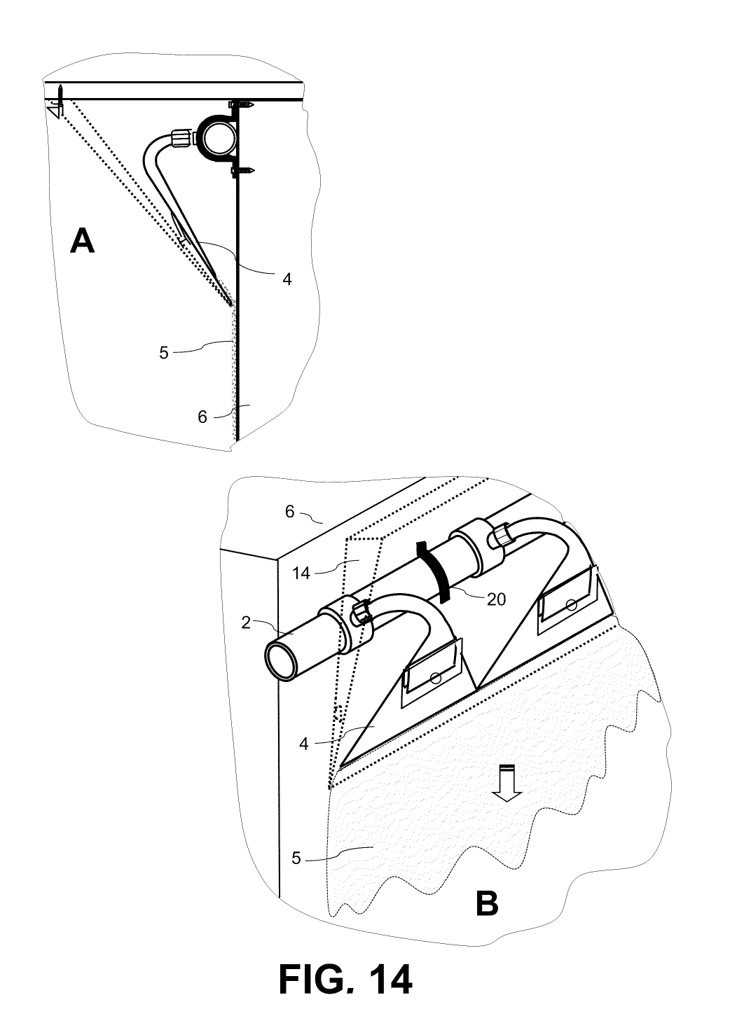

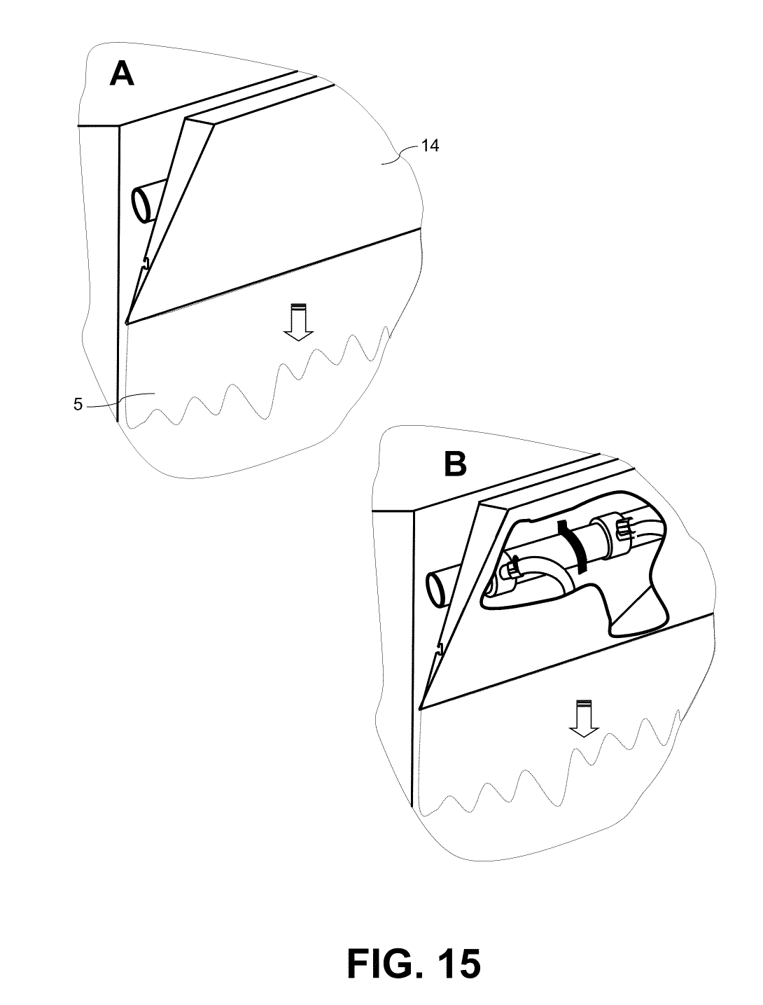

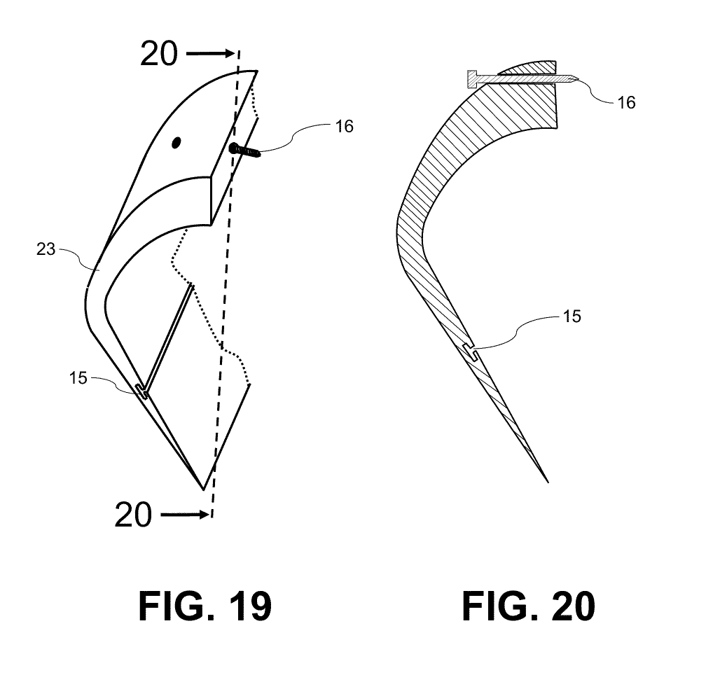

After connection to a secondary water pipe, through connecting pipes, the linear flat shield 14 carrying a plurality of nozzles is attached to the ceiling with a plurality of threaded fasteners 16. It has to be noted that such sequence of embodiment of the wall-nozzles 4 to the linear flat shield 14 is the same for the curved linear shield 23 which is described later starting on FIG. 19, and is adaptable to that particular embodiment. FIG. 13A shows a side view of wall piping assembly mounted on a wall 6 and a ceiling 22, including a secondary water pipe 2 secured on the wall 6 by supports 20 attached to the wall with threaded fasteners 21. The linear flat shield 14, supporting the wall-nozzles 4, is attached to the ceiling by a plurality of threaded fasteners 16. The layout of a wall-nozzle 4 anchored to a wall-nozzle plate support 17 mounted on the longitudinal linear flat shield 14 is detailed in a partial enlarged view, shown in FIG. 13B. In this view, the wall-nozzle 4 with its back anchor 11 anchored to a wall-nozzle plate support 17 secured to the flat linear shield 14 by a threaded fastener 19. For a better understanding of this embodiment, two views are shown in FIG. 14 where FIG. 14A is the same as the previous view in FIG. 13A but showing the water flow that is coming from wall nozzles 4, is spread on the wall 6 here as a water film 5. FIG. 14B is a perspective view of the same embodiment with a flat linear shield 14 transparent to depict two wall-nozzles 4 connected to the secondary water pipe 2, attached to the wall by supports 20, and the water protecting film 5 descending along the wall 6. The aesthetic of the present dynamic water protection system is depicted in FIG. 15. Thus, as shown in FIG. 15A, the longitudinal linear flat shield 14, as its decorative part of feature, hides from view, except the protecting water film 5, an installed wall piping assembly. The view in FIG. 15B is the same view but with a hole in the longitudinal linear flat shield 14 to show how the elements of the system are mounted behind it.

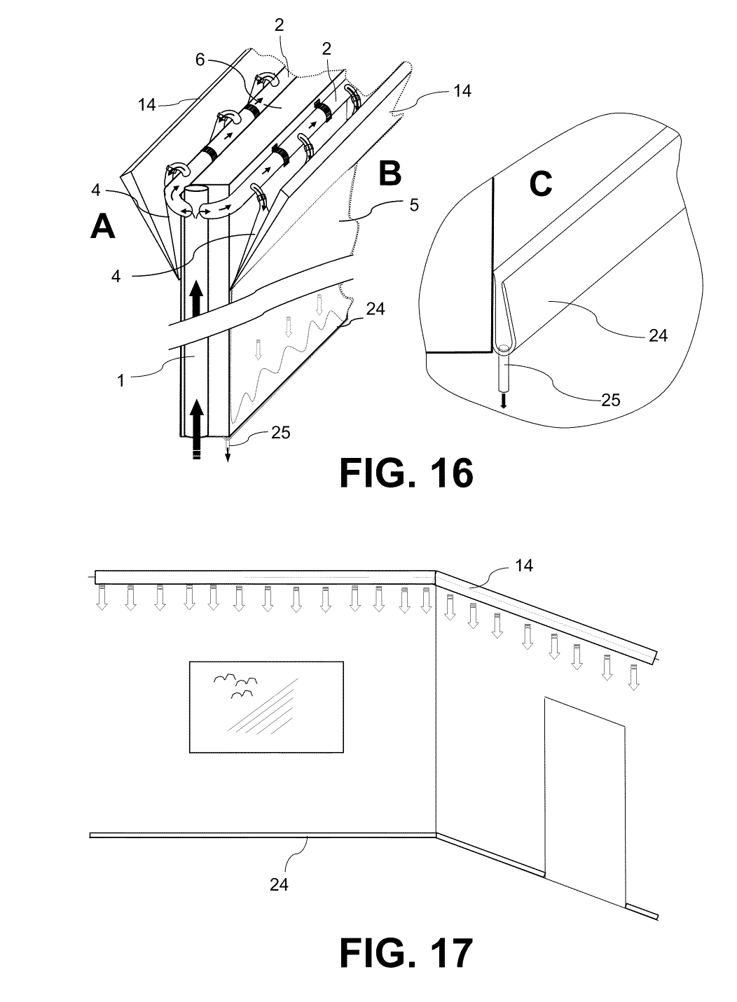

The present dynamic water shield protection system is designed for the protection of both the exterior and interior compartments of a building by covering both side surfaces of each wall. FIG. 16 is a perspective view of an example of an embodiment of the dynamic water shield fire protection system on a wall showing a portion of its installation on both sides of a wall 6 without the ceiling or roof in order to facilitate the view. During operation, pressurized water, from a pump or other means, is injected into the main water pipe 1 and oriented in secondary water pipes 2 attached along the highest line of both sides of the wall 6. The water is then driven toward the wall-nozzles 4 (only three on both side are shown), that are anchored to linear flat shields 14, and spreads on the surfaces of the wall 6 as a descending water film 5. Unlike for the exterior compartment (A), for the interior compartment (B), a wall-gutter 24 is installed along the bottom of the interior wall face to prevent flooding by driving the descending water towards outside or into the building evacuation plumbing system through an evacuation wall-gutter 25 as shown in an enlarged detailed view in FIG. 16C. The evacuated water may be recycled and reused in a loop for fighting the fire or for further use. In this perspective, the wall-gutter may be installed along exterior wall faces also to collect water used to protect exterior walls. Such embodiment is for adapting to situations where the availability of water is reduced.

It has to be noted that this schematic illustration is for informational purpose only. Thus, the vertical main water pipe 1 should be positioned exteriorly on the side the wall to enable a connection of a pump or other pressurized water source. Further, it has to be noted also that shape or design of the wall-gutter 24 should be more flat to be more aesthetic and discrete. Thus, as shown in FIG. 17, once installed inside a room, the system would not be visible except as longitudinal plates, which are the backs of the linear flat shields 14, at the top of the wall, and discrete longitudinal wall-gutters 24 at the bottom of the walls.

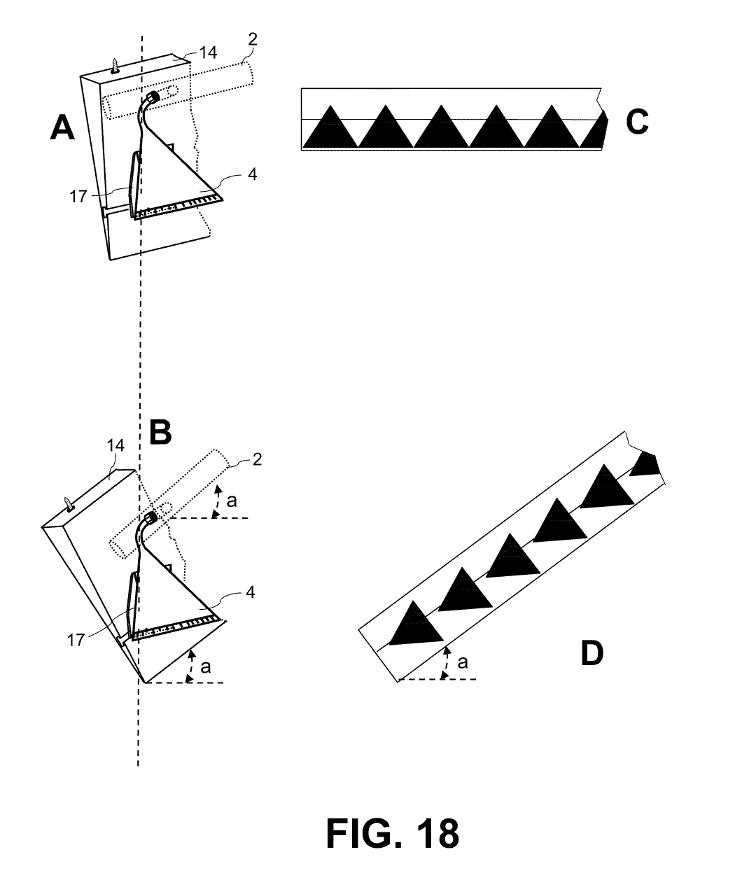

The embodiment including the secondary water pipe connected to a plurality of wall-nozzles can be adapted for horizontal and inclined installations. In horizontal embodiment, as shown in FIG. 18A, the wall-nozzle 4 is mounted vertically and thus the water flow will be spread vertically. In a non-horizontal embodiment, as shown in FIG. 18C, the wall-nozzle 4 is still mounted vertically on a linear flat shield 14 mounted with an a angle along of a surface. Thus, even in this inclined embodiment, the water flow from a wall-nozzle will be spread vertically as in the case of a horizontal embodiment. FIGS. 18C and 18D are schematic illustrations of a portion of a linear flat shield with several wall-nozzles, depicted as black triangles, in horizontal and inclined embodiments respectively. The orientation of wall-nozzles is achieved as described above in FIG. 12.

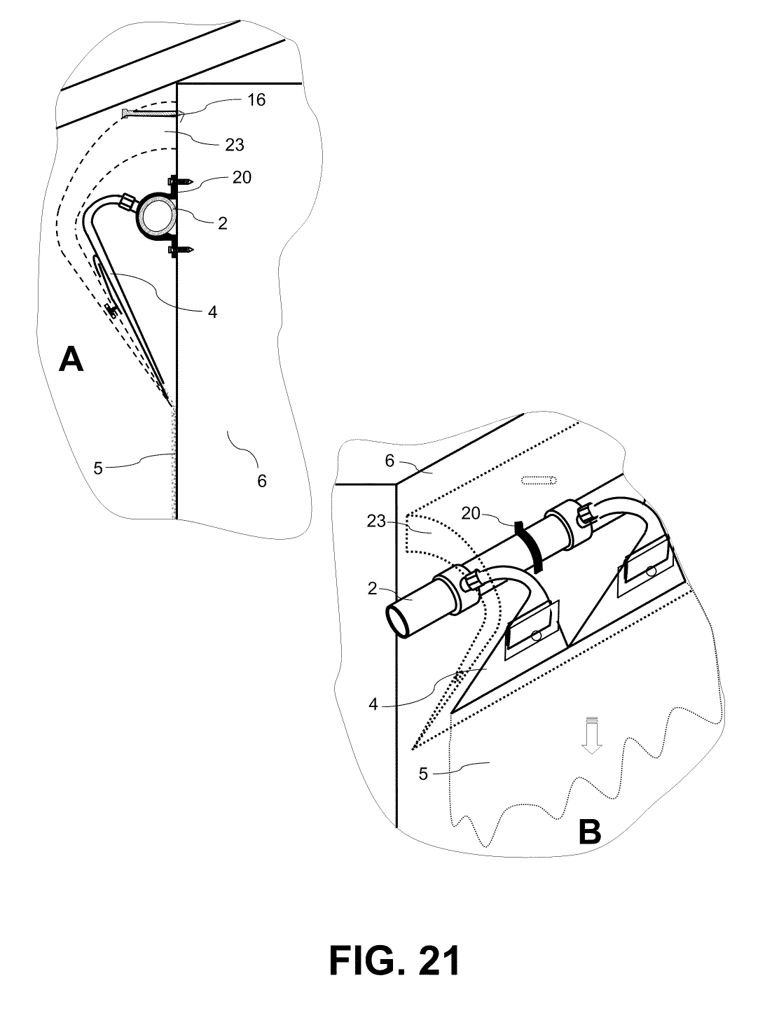

For outside installation of a wall piping assembly, a longitudinal linear curved shield is designed with a curved section to enable a better protection of the installed wall piping assembly from the weather. Moreover, in contrary with longitudinal linear flat shield, the installation of a wall piping assembly with longitudinal linear curved shield does not require a ceiling and thus is adapted for exterior walls. It has to be noted that a longitudinal linear curved shield may be installed also on interior walls. FIG. 19 shows a portion of such a longitudinal linear curved shield 23 and its side cross-section view is shown in FIG. 20, depicting a longitudinal track 15 to enable the anchoring of a wall-nozzle, as described above in detail and its curved or concave shape covering the wall piping assembly and enabling attachment to a wall. Thus, a plurality of holes at the top of the longitudinal linear curved shield enables a direct attachment to a wall with threaded fasteners 16. FIG. 21 shows a wall piping assembly with a linear curved shield installed over it on an exterior wall. FIG. 21A is a side view depicting the layout of the members of a wall piping assembly showing a wall-nozzle 4 anchored to a longitudinal linear curved shield 23 attached to a wall 6.

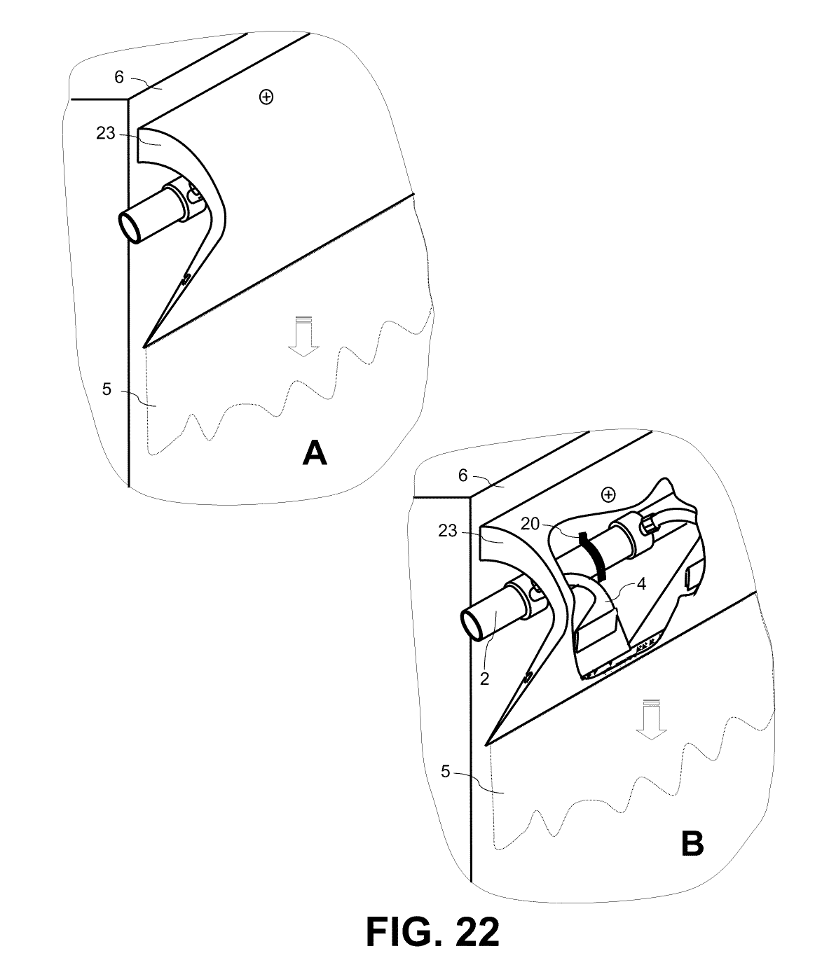

The wall-nozzle 4 is fluidly connected to the secondary water pipe 2; the secondary water pipe is attached to the wall via a plurality of supports 20; the supports are secured to the wall 6 by threaded fasteners. The wall-nozzle 4 connected to the secondary water pipe 2 spreads the water against the wall 6 as a thin descending water film 5. FIG. 21B is a perspective view of the same embodiment with a linear curved shield 23 in transparent view to depict the connection of the wall-nozzles 4 to the secondary water pipe 2, and the water protecting film 5. As with a longitudinal linear flat shield, a longitudinal linear curved shield is designed to have dual roles: a decorative and a supportive. Thus, as shows in FIG. 22A, when it is installed, a longitudinal linear curved shield 23 completely hides from view a wall piping assembly mounted on a vertical wall 6. Only the covering water film 5 is visible when the system is activated. The view in FIG. 22B is the same view but with a hole in the longitudinal linear curved shield 23 to show how the elements of the system are hidden behind it.

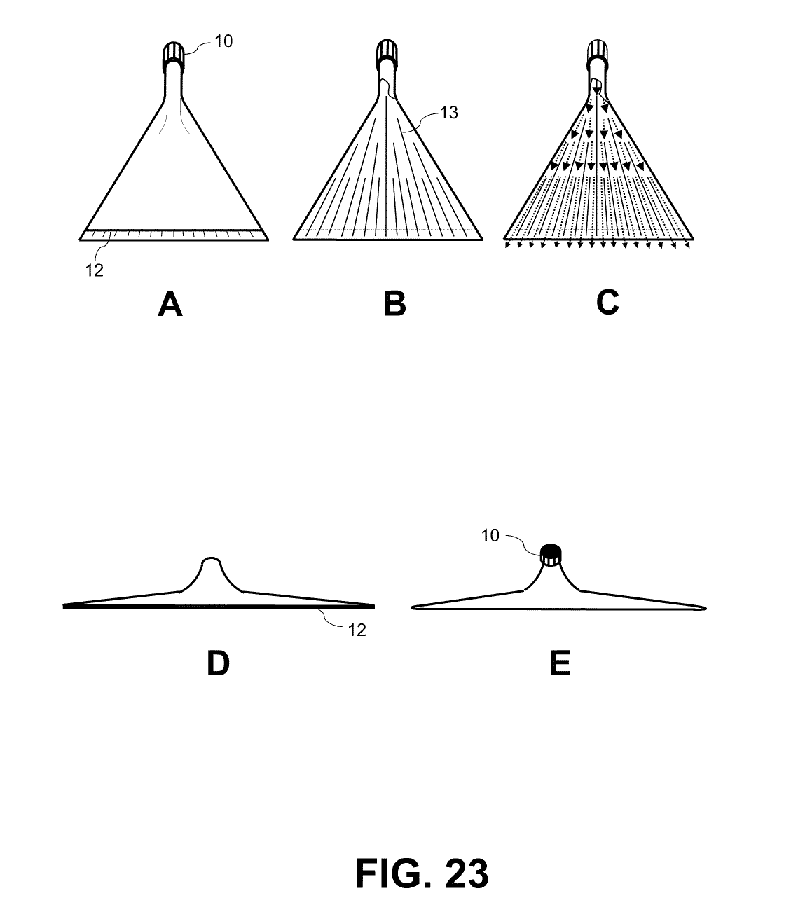

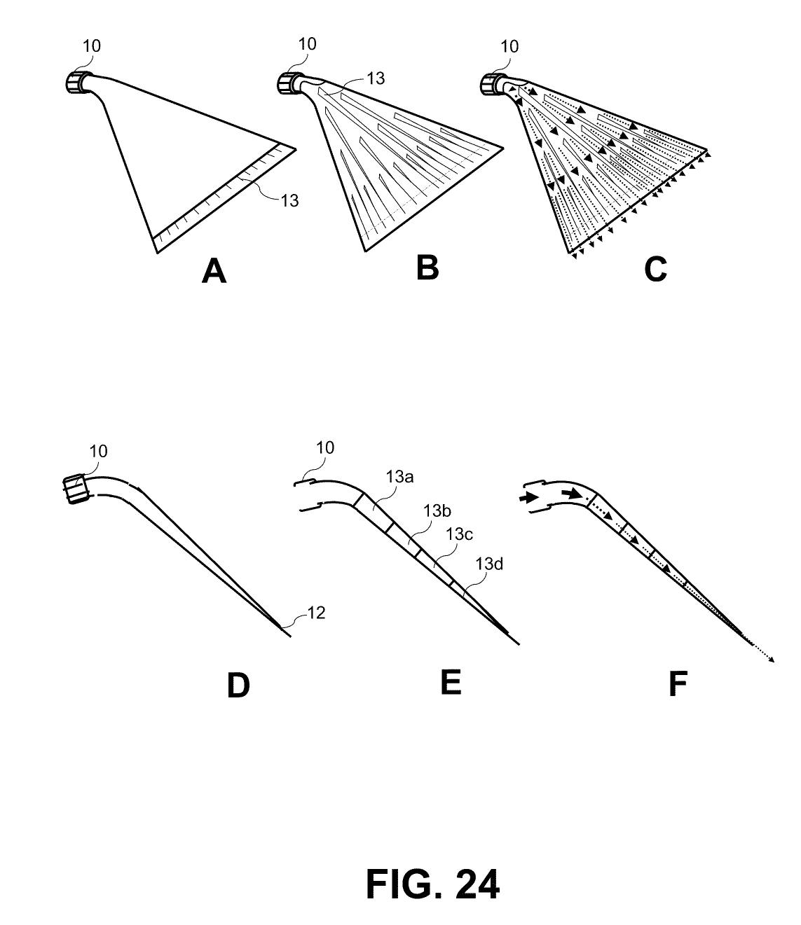

For inclined surfaces such as roofs, a special nozzle is designed as depicted in FIGS. 23 and 24. FIG. 23 shows different detailed views of a roof-nozzle 26 where FIG. 23A depicts a top front external view of the nozzle with a female thread end 10 for inlet connection to a secondary water pipe. As with a wall-nozzle, the outlet end 12 is flat part of the nozzle and the neck of the roof-nozzle 26 can also be curved in such way to enable a better connection to connecting pipe. FIG. 23B is a transparent view of the body of a roof-nozzle 26 showing inside to reveal the disposition of directional blades 13 to orient the water flow, coming from the inlet neck of the nozzle, on all the surface of the nozzle outlet 12 as indicated by the arrows in the FIG. 23C. As with a wall-nozzle described previously above, the directional blades 13 are positioned radially in the flat part of the nozzle from the cylindrical neck to the flat outlet 12 of the nozzle and direct the water flow in the same way. FIG. 23D shows a front view of a roof-nozzle depicting the flatness of its outlet 12 while FIG. 23E is a rear view of a roof-nozzle depicting the progressive flattening of the nozzle from the cylindrical inlet to the V-shape flat part and the position of the inlet female thread 10. FIGS. 24A to 24C are perspective views of a roof-nozzle depicting its V-shape, and position of the inlet female thread 10. The radial disposition of the internal directional blades 13 is shown in transparent view in FIG. 24B and the water flow circulation inside the nozzle is shown in FIG. 24C. FIGS. 24D to 24F show side views of a roof-nozzle 26 depicting its progressive flatness from the cylindrical and curved neck inlet end with a female thread 10 to the flat outlet 12 and the size and shape of internal directional blades 13 designed as 13a for the primary directional blade, 13b for secondary directional blades, 13c for tertiary directional blades and 13d for quaternary directional blades. The respective roles of these directional blades are the same as described previously above for a wall-nozzle. Therefore, except for the orientation of their cylindrical inlet neck, a wall-nozzle and a roof-nozzle share the same external and internal design characteristics. However, in the case of the wall-nozzle the cylindrical inlet end is oriented toward the outlet of the nozzle while, in the case of the roof-nozzle, this inlet end is oriented in opposite direction of the outlet of the nozzle. Finally, only a wall-nozzle has, on the back, a back-anchor 11 enabling its hanging to a longitudinal linear shield as described above while roof-nozzles rest on the roof when they are mounted.

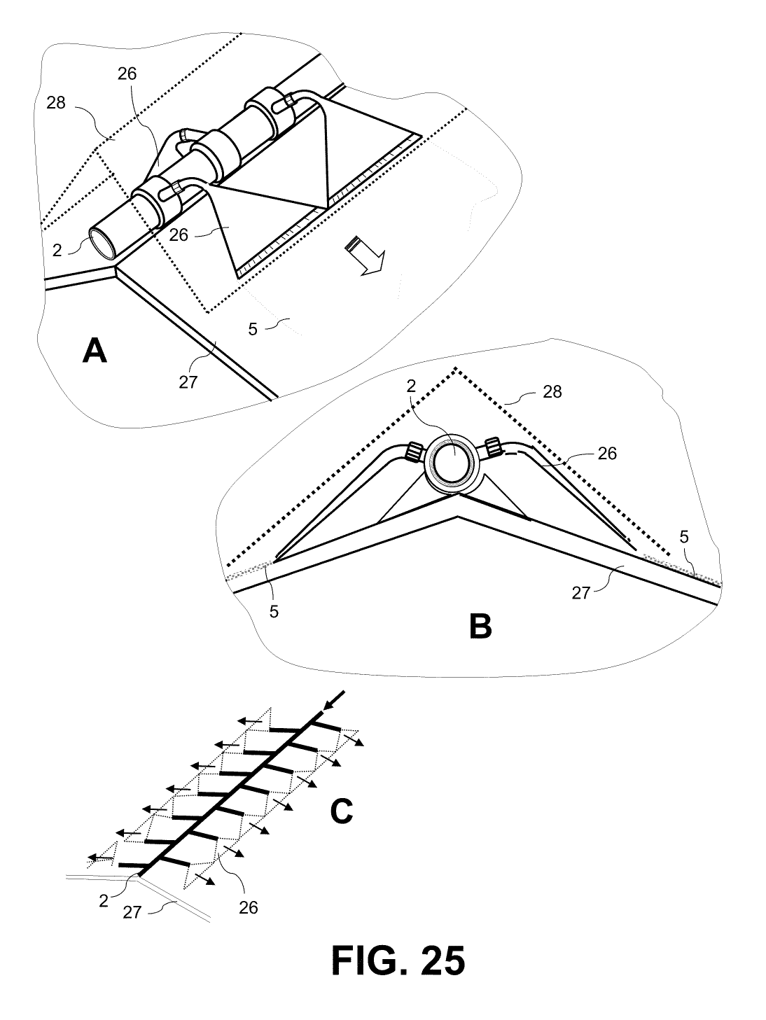

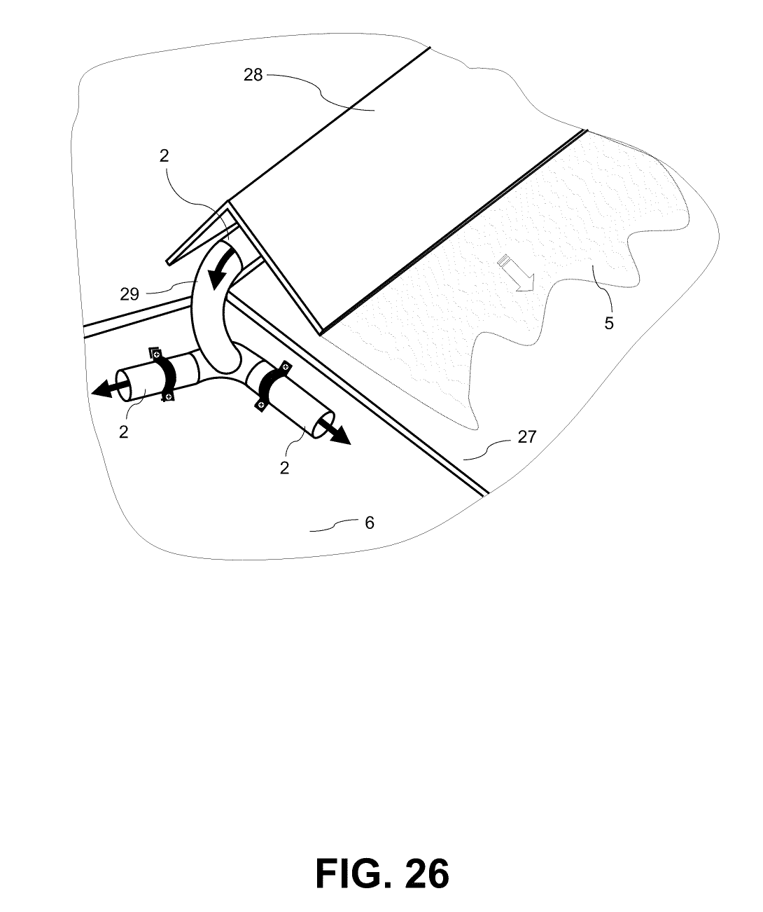

In ideal embodiment, as shown in FIG. 25, roof-nozzles 26 are connected alternatively and perpendicularly to a secondary water pipe 2. The roof-nozzles 26 are oriented outwardly along both sides of the edge of the roof 27 in such a way that the water spray from each nozzle merges with the water spray from the adjacent nozzle to form a water film 5 on surfaces of the roof 27. FIG. 25A shows a close perspective view of a portion of a secondary water pipe 2 installed at the crest of a roof and connected to three roof-nozzles 26 and the protecting water film 5 from two adjacent roof-nozzles 26 on one side. Shown also is a conventional top covering longitudinal elongated shield 28 which shields the roof piping assembly. FIG. 25B is a side view of a roof piping assembly installed on the crest of a roof depicting the layout of the members of the assembly. It should be noted that the outlet ends of the roof-nozzles 26 are in contact with the surface of the roof 27 in such way that the water directly spreads on the roof. FIG. 25C is a diagram illustrating the central position of the secondary water pipe 2 connected perpendicularly to a plurality of roof-nozzles 26 mounted alternatively on both sides along the crest of the roof. FIG. 26 shows a close perspective view of a portion of a roof piping assembly depicting a conventional longitudinal cover shield 28 and a curved connector 29 enabling a fluid communication of the secondary water pipe 2, installed on the roof, to secondary water pipes 2 located on the wall under-eave of the roof 27.

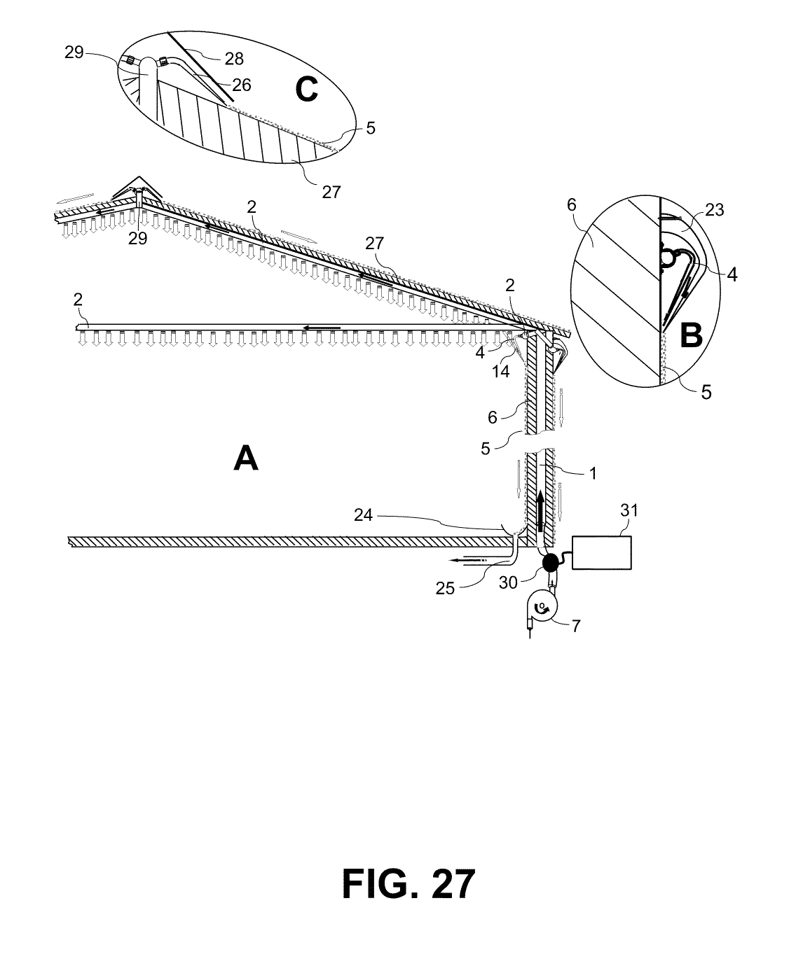

The different parts and assemblies of the present dynamic water shield fire protection system thus described, this section will be focused on a general embodiment on a typical house to give a panoramic view of the invention. Thus, FIG. 27 shows a general partial side cross-section view of a house summarizing a preferred embodiment of the present fire prevention system invention and the location of mounted components. FIG. 27A illustrates a disposition of wall-nozzles mounted horizontally and non-horizontally as depicted by the white arrows. As shown, in both case, the orientation of the wall-nozzles is always vertical and directed downwardly. During operation, a pump 7 or any water supply system forces up the water to the vertical main water pipe 1. The pressurized water flow is oriented to longitudinal secondary water pipes 2 positioned longitudinally along the crest or ridge of the roof and along the highest line of both sides of each vertical wall 6. Connecting pipes enable the delivery of the pressurized water to a plurality of nozzles oriented in such way that the water flows from adjacent nozzles are merged into a water film spreading on the roof 27 and the wall 6. For the aesthetic purpose, as previously described above, the mounted wall-nozzles are hidden behind a linear flat shield 14. Flooding of the interior compartment by the descending water film 5 is prevented by a wall-gutter 24, placed horizontally along of the bottom of the interior side of the house walls and connected to the exterior by an evacuation pipe 25. Such evacuation pipe 25 may be connected to the evacuation plumbing of the house or the building. In an ideal embodiment, when the water source is limited such as to a pool or a tank, the evacuation pipe 25 may be redirected to the water source. For the exterior side of the wall 6, a plurality of wall-nozzles 4, connected to a secondary water pipe 2, are hidden behind a linear curved shield 23, as shown in an enlarged view in FIG. 27B. The embodiment on the roof is depicted in an enlarged side view in FIG. 27C. The secondary water pipe attached to the crest of the roof, hidden on the figure by the curved connector 29, is connected perpendicularly to the inlets of a plurality of roof nozzles 26 through connecting pipes. The flat outlets of the roof nozzles 26 are placed on the roof to enable easy and efficient water spread in such way that the water flows from all roof nozzles 26 merge to form uniform thin water film 5 covering the entire surface of the roof 27. A conventional covering, longitudinal elongated shield, 28 is mounted along the ridge of the roof 27 and over the roof piping assembly to shield the roof piping assembly. In this preferred embodiment, the flow of water in the system may be controlled by an electrically operated valve 30 which is in turn controlled by a central command assembly 31. The pressurized water being supplied by a pump 7 connected to a water supply, by a fire hydrant, wet standpipe or conventional water tap supply system. The central command assembly 31 and the valve 30 may be the same as those commonly employed on automatic sprinkler systems. Such system can be automatically and remotely activated for preselected times or by heat for inside and outside use ideally placed and sending signals to the central command assembly 31 to deliver pressurized water only to nozzles located in the building where an impending fire is threatening. It should be noted that the fire protection system can also be turned on and off manually by a one-way valve installed above the inlet of the main water pipe 1.

Having thus described a preferred embodiment of the present invention, it should be apparent to those skilled in the art that certain advantages of the system have been achieved. For example, most of the components of the dynamic water shield fire protection system described herein are installed in a manner that provides protection from the external and internal environments when the system is inactive, thus reducing corrosion and increasing reliability. It should also be appreciated that various modifications, adaptations, and alternative embodiments thereof may be made within the scope and spirit of the present invention. For example, it is contemplated that various combinations of the embodiments described herein may be merged into one or more systems. It is also contemplated that the present dynamic water shield prevention system can be implemented in any structure in any environment, including city, suburban, rural environments and boats. As to the manner of usage and operation of the present invention, the same should be apparent from above description. Accordingly, no further discussion relating to the manner of usage and operation will be provided.

With respect to the above description then, it is to be realized that the optimum dimensional relationships for the part of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed in the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalent may be resorted to, falling within the scope of the invention.

I claim:

1. A dynamic water shield fire protection system for protecting a building from fire, by creating running water films covering roof and wall surfaces, the dynamic water shield fire protection system comprising in combination:
a pressurized water supply assembly, comprising a pressurized water supply system and a main water pipe, for providing pressurized water;
a central command assembly for controlling the delivery of the pressurized water;
a network of secondary water pipes fluidly connected to the main water pipe of the pressurized water supply assembly, each secondary pipe being fluidly connected to a plurality of nozzles;
a roof piping assembly mounted along a peak of a roof of a building for protection of a roof;
a wall piping assembly extending along the highest line of a wall surface for protection of a wall; and
a drain assembly for collecting the water coming down the roof and wall surfaces.

2. A dynamic water shield fire protection system according to claim 1, wherein said pressurized water supply assembly comprising a pressurized water supply system and a main water pipe, the pressurized water supply system delivering water under pressure to the inlet end of the main water pipe.

3. A dynamic water shield fire protection system according to claim 1, wherein said central command assembly is connected to the pressurized water supply system and comprising a plurality of fire detectors and an activator unit, the plurality of the fire detectors being installed inside and outside of a building for transmitting signals thereto upon the detection of a signal greater than selected thresholds to the activator unit to trigger the delivery of pressurized water to the main water pipe and to the secondary water pipes located in areas threatened by an impending fire.

4. A dynamic water shield fire protection system according to claim 1, wherein said roof piping assembly further comprising a secondary water pipe that is a member of a network of secondary water pipes, a plurality of connecting pipes, a plurality of roof-nozzles and an elongated top shield, the secondary water pipe being in fluid communication with the main water pipe of the pressurized water supply system and connected to the plurality of connecting pipes, the connecting pipes being regularly positioned at spaced locations and fluidly coupled to an equivalent number of roof-nozzles, the roof-nozzles extending outwardly along a peak of a roof of a building, the elongated top shield being fastened to the roof over the rest of the roof piping assembly to serve as cover.

5. A roof piping assembly according to claim 4, wherein said roof-nozzle is used for protecting a roof surface with a water film, said roof-nozzle being a nozzle with an elongated inlet neck with a thread, and a progressively widening and flattening V-shaped body with internal directional blades or pipes radially disposed from the neck toward a flat outlet.

6. A dynamic water shield fire protection system according to claim 1, wherein said wall piping assembly, installed along the highest line of a wall surface, further comprising a secondary water pipe that is a member of a network of secondary water pipes, a plurality of connecting pipes and a nozzle-shield support assembly, the secondary water pipe being in fluid communication with the main water pipe of the pressurized water supply system and fluidly connected to the plurality of connecting pipes, the connecting pipes being regularly positioned at spaced locations.

7. A wall piping assembly according to claim 6, wherein said nozzle-shield support assembly further comprising a linear shield, a plurality of wall-nozzle plate supports and a plurality of wall-nozzles, the plurality of wall-nozzles being supported by an equivalent number of wall-nozzle plate supports mounted on the linear shield, the plurality of wall-nozzles being fluidly coupled to an equivalent number of the connecting pipes.

8. A wall piping assembly according to claim 7, wherein said linear shield supporting the wall-nozzles and hiding the fluid connection of the wall-nozzles, said linear shield being an elongated plate with a generally triangular or concave side cross-section, the linear shield having a plurality of fasteners and at least one track along the internal face.

9. A wall piping assembly according to claim 7, wherein said wall-nozzle plate support being a generally rectangular plate with a cylindrical neck on the back, the cylindrical neck being extended by a circular base, the cylindrical neck and the circular base having a central hole through which to thread a fastener.

10. A wall piping assembly according to claim 7, wherein said wall-nozzle is used for protecting a wall surface with a water film, said wall-nozzle being a nozzle with an elongated inlet neck with a thread, a back anchor and a progressively widening and flattening V-shaped body with internal directional blades radially disposed from the neck toward a flat outlet.

11. A dynamic water shield fire protection system according to claim 1, wherein said drain assembly is installed along the bottom of a wall, the drain assembly comprising a wall-gutter, a gutter adjusted to fit along a wall, with at least one drain, and at least one drain pipe connecting the gutter fluidly to a water evacuation pipe or to a water recycling system.

12. A Method for a dynamic water shield fire protection system comprising the steps of:
a) bringing pressurized water to a network of fluidly interconnected water pipes positioned along the highest line of a roof and along the highest line of a wall;
b) redirecting the pressurized water, from the water pipes, in a plurality of water flows toward the roof and wall surfaces;
c) covering the roof and wall surfaces with the plurality of water flows merging to form a dynamic water film shield;
d) collecting the water coming down the roof and wall surfaces for evacuation or recycling; and
e) Repeating the steps from step a) to step d).

13. A Method for a dynamic water shield fire protection system according to claim 12, wherein pressurized water is delivered to a network of fluidly interconnected water pipes.

14. A Method for a dynamic water shield fire protection system according to claim 12, wherein a plurality of water flows is spread outwardly from the water pipes toward roof surfaces.

15. A Method for a dynamic water shield fire protection system according to claim 12, wherein a plurality of water flows is spread outwardly from the water pipes toward wall surfaces.

16. A Method for a dynamic water shield fire protection system according to claim 12, wherein a drain assembly is installed at the bottom of walls to collect and evacuate or recycle water coming down from wall surfaces.
